(19) United States
(12) Patent Application Publication
(10) Pub. No.: US 2016/0170569 A1
(43) Pub. Date: Jun. 16, 2016

(54) FLIGHT TRAVELLER SITUATION AWARENESS SYSTEM

(71) Applicant: Atech Negócios em Tecnologias S.A., Sao Paulo (BR)

(72) Inventors: Denis Lima BALAGUER, Sao Paulo (BR); Marcos Ribeiro RESENDE, Sao Paulo (BR)

(21) Appl. No.: 14/966,743

(22) Filed: Dec. 11, 2015

Related U.S. Application Data
(60) Provisional application No. 62/091,789, filed on Dec. 15, 2014.

(51) Int. Cl. G06F 3/0481; G06F 3/0484; G06Q 30/02

(52) U.S. Cl. CPC G06F 3/0481; G06Q 30/0241; G06F 3/04842

(57) ABSTRACT

A system directed to a help flight traveler keep aware of the conditions related to the flight journey (e.g. flight delays, airport queues, parking occupancy), to share information with friends, relatives and service providers to promote integration with the business related to this journey (airport stores, hotels, transport firms) is disclosed.

### REFERENCE TO RELATED APPLICATION

This application claims priority of U.S. provisional patent application Ser. No. 62/091,789, filed Dec. 15, 2014, and hereby incorporates this provisional patent application by reference herein in its entirety.

### BACKGROUND

1. Field of the Invention

The present invention is a system directed to a help flight traveler keep aware of the conditions related to the flight journey (e.g. flight delays, airport queues, parking occupancy) and promote integration with the business related to this journey (airport stores, hotels, transport firms).

2. Description of the Related Art

There are systems (including mobile apps) that bring information regarding flight status and aspects of the airports environment. There are also systems that provide information regarding the services within the airports. No system provides fully integrated awareness regarding the flight travel journey.

### SUMMARY

Provided herein is a system for providing situational awareness to air travelers regarding the aspects of the journey, from its begin to its end.

The system integrates, through a data-fusion algorithm, information collected from automatic sources and crowd sourced sources.

The system provides time estimates regarding each step to the flight travel journey.

The system updates the time estimates in real time, based upon updates in the information collected.

The system allows the user to simulate new time estimates scenarios based upon changes in inputs regarding the steps of the journey.

The system allows the user to share the time estimates with thirds.

The system automatically provides relevant business offers to the user, base on the journey status and conditions.

The system allows the traveler to share its information in social platforms or directly by email and SMS.

The system provides a platform for the airport and travel related business find relevant customers, based on real time conditions, and market offers to these customers.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

The invention may best be understood by reference to the following description taken in conjunction with the accompanying drawings in which:

FIG. 1 shows a schematic diagram of information and processing flow for the flight traveler journey timing estimation, visualization and decision support.

FIG. 2 shows a schematic diagram of information and processing flow for the flight traveler linkage with business offers relevant to the journeys' specific moment and conditions.

FIG. 3 shows a schematic diagram of information for the sharing of the traveler's information.

### DETAILED DESCRIPTION

The following embodiments describe system directed to a help flight traveler keep aware of the conditions related to the flight journey (e.g. flight delays, airport queues, parking occupancy) and promote integration with the business related to this journey (airport stores, hotels, transport firms).

FIG. 1 shows a schematic diagram of information and processing flow for the flight traveler journey timing estimation, visualization and decision support.

To provide situation awareness, the systems fusions time related information as well as conditions related information. This information is collected both from automatic sources (i.e., without any direct action by user) and crowd sourced (i.e., are provided by the user through a direct input in the system).

The automatic sources information collection is based upon sensors embedded in mobile devices (e.g. GPS, Bluetooth, Wi-Fi, Accelerometer) and information provided by other systems (e.g. road traffic information systems, parking information systems, public transport information system, weather system, air traffic information system). The kind of information most likely to be collected automatically is the ones regarding location, path, schedule, presence, movement timing, proximity and others.

The crowd sourced information collection is based upon a direct input by the user, made through a dedicated interface on the system. The kind of information most likely to be collected via crowd source is the ones regarding condition in the flight travel journey, such as queue extensions and duration, parking availability and conditions, security and cleanness of the facilities and others.

The system has especially designed algorithm to fusion these information. With this fusion, the system provides an estimate of the length of each of the journey's steps, and present action recommendations the traveller. This data fusion takes in account both the historical data and data being inputted in real time (both from automatic sources and crowd sources).

Once calculated the length of each of the journey's steps and the recommended action, the system displays to the traveller an integrated visualization. This visualization shows the time estimative and the major hurdles through the journey.

With the integrated visualization, the system provides to the traveller the possibility to make inputs with its preferences, such as transport, parking and check in choices. Once the traveller made such inputs, the system recalculates its estimates an presents the new scenario to the user.

The system also allows the traveller to send its estimates scenario to other people with interests in keeping track in real time of its schedule.

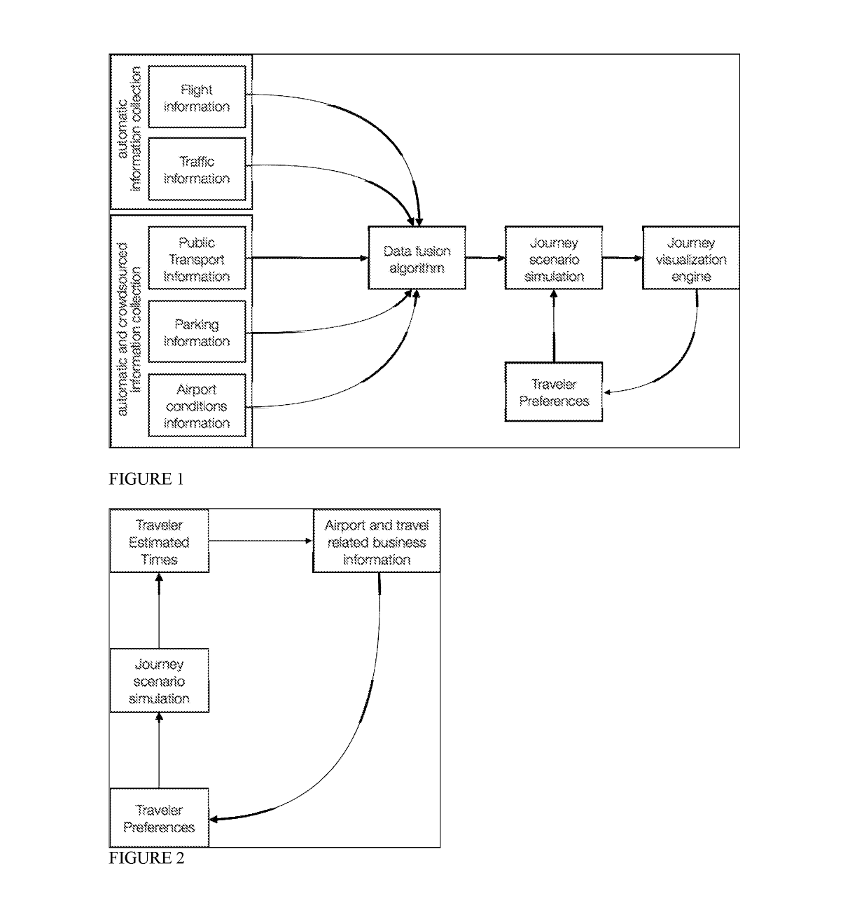

FIG. 2 shows a schematic diagram of information and processing flow for the flight traveler linkage with business offers relevant to the journeys' specific moment and conditions.

Based on the real time availability of the traveller schedule, the system enables a direct interaction with the business ecosystem related to the air travel journey (e.g. taxi, airport's stores, parking, car rental and sharing, transport services, hotels).

The system provides this traveller information through a dedicated business platform. The business owner or operator can, based on a pre-established rule set or and real time action, provided relevant offers that are context aware (e.g., if there is a flight delay, a coffee shop can offer an 10% discount to the traveler.)

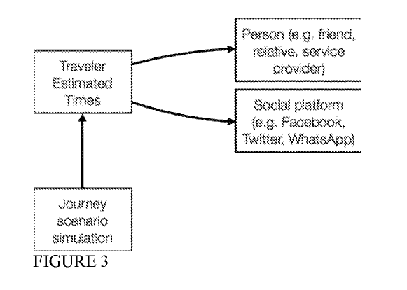

FIG. 3 shows a schematic diagram of information for the sharing of the traveler's information.

Based on the real time estimates of the traveler's journey, the system send, automatically or upon request, updates to people selected by the traveler or groups defined by previous definition. The system is integrated with social platforms, such as Facebook, Twitter and WhatsApp.

1. An integrated situational awareness system configured to support air traveler decision making through visualization and analysis of time and events regarding stages of the air travel journey, the system comprising:
a. a time estimator configured to calculate an amount of time required for stages between a starting point and an end point of a journey, through fusion of automatic data and crowd sourced data;
b. a display configured to display:
events regarding each of the stages;
updates, in real time, of any changes in flight schedules;
an actualized estimated time of disembarkation; and
information relevant and context aware for each stage; and
c. a communications module configured to:
facilitate sharing by the traveler of the presented information; and
provide a timely and context aware link between the traveler, an airport and a travel related business.

2. The system of claim 1 wherein respective ones of the stages are selected from among the following:
traffic to the airport;
public transport;
parking;
check-in;
security check;
boarding;
flight plan;
baggage claim; and
customs.

3. The system of claim 2 wherein the automatic data comprises data sourced from one or more of the following:
GPS;
Bluetooth;
beacons; and
accelerometers.

4. The system of claim 3 wherein the events displayed comprise one or more of the following:
long queues;
strikes; and
flight delays.

5. The system of claim 1 wherein the presented information comprises advertising.

6. The system of claim 1 wherein the communications module is configured to facilitate sharing by the traveler of the presented information in social media platforms, directly by email, or SMS.

7. A method of supporting decision making of an air traveler through visualization and analysis of time and events regarding stages of an air travel journey, through use of an integrated situational awareness system, the method comprising:
a. calculating a time estimate for stages between a starting point and an end point of the journey, wherein the time estimate is made through fusion of automatic data and crowd sourced data;
b. displaying events regarding each of the stages;
c. updating, in real time, any changes in flight schedules;
d. displaying an actualized estimated time of disembarkation;
e. presenting information relevant and context aware for each stage;
f. facilitating sharing by the traveler of the presented information;
g. providing a timely and context aware link between the traveler, an airport and a travel related business.

8. The method of claim 7 wherein respective ones of the stages are selected from among the following:
traffic to the airport;
public transport;
parking;
check-in;
security check;
boarding;
flight plan;
baggage claim; and
customs.

9. The method of claim 8 wherein the automatic data comprises data sourced from one or more of the following:
GPS;
Bluetooth;
beacons; and
accelerometers.

10. The method of claim 9 wherein the events displayed comprise one or more of the following:
long queues;
strikes; and
flight delays.

11. The method of claim 7 wherein the presented information comprises advertising.

12. The method of claim 7 wherein the facilitating comprises sharing by the traveler of the presented information in social media platforms, directly by email, or SMS.
